(19) United States
(12) Patent Application Publication
(10) Pub. No.: US 2018/0368371 A1
(43) Pub. Date: Dec. 27, 2018

(54) Flotation Device

(71) Applicant: William J. Warren, Frisco, TX (US)

(72) Inventor: William J. Warren, Frisco, TX (US)

(21) Appl. No.: 16/005,656

(22) Filed: Jun. 11, 2018

Related U.S. Application Data
(60) Provisional application No. 62/522,831, filed on Jun. 21, 2017.
(60) Provisional application No. 62/524,497, filed on Jun. 24, 2017.

(51) Int. Cl. A01K 39/014; G05D 1/02

(52) U.S. Cl. CPC A01K 39/014; H04W 4/80; G05D 1/0206

(57) ABSTRACT

A flotation device apparatus for containing a material that floats atop a body of liquid is described herein. The flotation device apparatus can contain a material such as animal feed, or a decorative material. The apparatus is configured to float atop a body of liquid, such as atop a swimming pool. When the apparatus is used to contain bird feed, it allows birds to perch upon it to consume the feed, without the risk of unintended animals, such as squirrels, consuming the feed.

### CROSS-REFERENCE TO RELATED APPLICATIONS

The present application claims the priority benefit of U.S. Provisional Application No. 62/522,831 filed on Jun. 21, 2017, and also claims the priority benefit of U.S. Provisional Application No. 62/524,497 filed on Jun. 24, 2017. The above-referenced applications are hereby incorporated by reference herein in their entirety for all purposes, including any references cited therein.

### FIELD

The present invention pertains to an apparatus that floats atop a body of liquid.

### SUMMARY

Various embodiments of the present disclosure are directed to a flotation device apparatus. In exemplary embodiments, the flotation device apparatus may float atop a body of liquid, and may be used to contain bird feed. By floating atop a body of liquid, the bird feed may be consumed by the intended birds, and not by squirrels or other animals.

In other exemplary embodiments, the flotation device apparatus may also contain rods extending outwards to protect the device from a perimeter of the body of liquid, such as a perimeter of a swimming pool.

In further exemplary embodiments, the flotation device apparatus may contain a motor, sensor(s), microprocessor(s), and/or wireless communication capabilities.

Other features, examples, and embodiments are discussed further below.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1A depicts an exemplary flotation device with an outer ring.

FIG. 1B and FIG. 1C depict exemplary configurations of an outer ring for the exemplary flotation device of FIG. 1A.

FIG. 2A depicts another exemplary flotation device with an outer ring.

FIG. 2B and FIG. 2C depict exemplary configurations of an outer ring for the exemplary flotation device of FIG. 2A.

FIG. 3 depicts another exemplary flotation device.

FIG. 4 depicts an underside view of an exemplary flotation device.

FIG. 5 depicts a side view of an exemplary flotation device.

FIG. 6 depicts a diagrammatic representation of an example machine, or computing unit, in the form of a computer system.

### DETAILED DESCRIPTION

The present disclosure is now described more fully with reference to the accompanying drawings, in which example embodiments of the present disclosure are shown. The present disclosure may, however, be embodied in many different forms and should not be construed as necessarily being limited to the example embodiments set forth herein. Rather, these example embodiments are provided so that the disclosure is thorough and complete, and fully conveys the concepts of the present disclosure to those skilled in the art. Also, features described with respect to certain example embodiments may be combined in and/or with various other example embodiments. Different aspects and/or elements of example embodiments, as disclosed herein, may be combined in a similar manner. Further, at least some example embodiments may individually and/or collectively be components of a larger system, wherein other procedures may take precedence over and/or otherwise modify their application. Additionally, a number of steps may be required before, after, and/or concurrently with example embodiments, as disclosed herein. Note that any and/or all methods and/or processes, at least as disclosed herein, can be at least partially performed via at least one entity, at least as described herein, in any manner, irrespective of the at least one entity have any relationship to the subject matter of the present disclosure.

Generally described, the present disclosure is directed to various embodiments of a flotation device. The flotation device may be configured to float atop any body of liquid. Further, the flotation device may be configured with at least one bowl to contain animal feed, such as bird feed. Having the feed in an enclosed bowl that floats atop a body of liquid may prevent squirrels or other unwanted animals from consuming the feed.

Flotation device may optionally also have wireless communication capabilities to allow for remote control of the flotation device. The flotation device can be configured to be placed in any body of liquid, either indoors or outdoors.

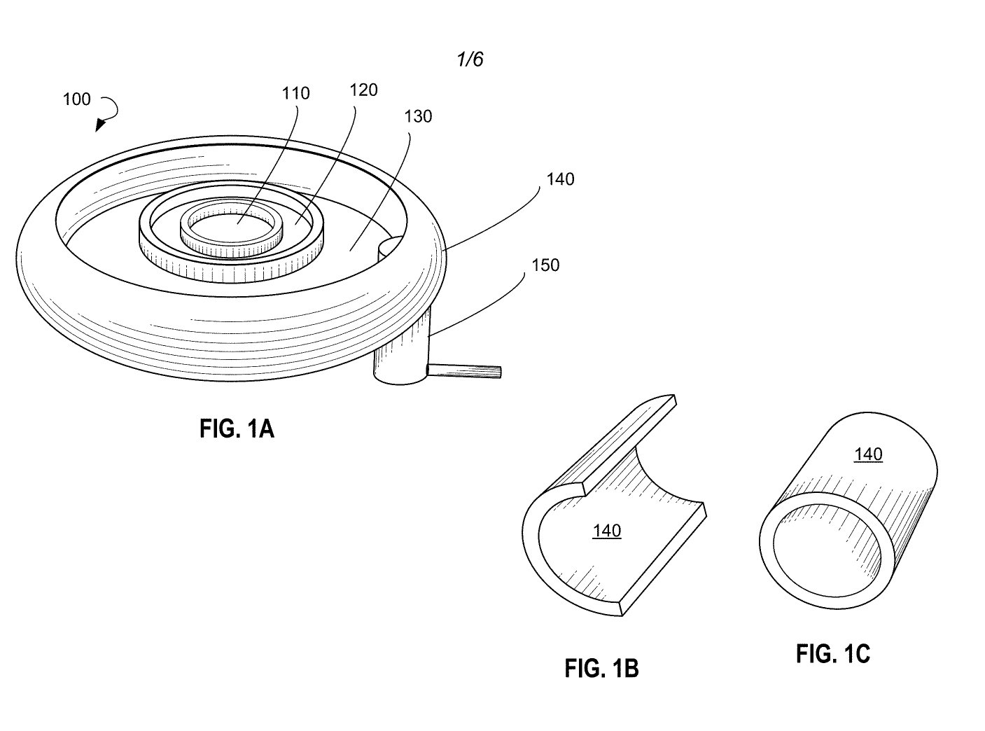

FIG. 1A depicts an exemplary flotation device 100. The flotation device 100 comprises an inner bowl 110, an outer bowl 120, a base plate 130, an outer ring 140, and a plurality of rods 150. In exemplary embodiments, one or more components of flotation device 100 can be constructed of Styrofoam, plastic, or any other suitable material that floats in a liquid, such as water.

Inner bowl 110 may be constructed of any suitable material that may or may not be capable of floating in a liquid by itself. Inner bowl 110 is depicted in exemplary FIG. 1A as being substantially circular in shape, from a top view. However, as would be understood by persons of ordinary skill in the art, inner bowl 110 may be of a different shape in other embodiments. For example, inner bowl 110 can be oval, square, rectangle, pentagon, hexagon, septagon, octagon, or any other shape, in various embodiments.

In an exemplary embodiment, inner bowl 110 is utilized to hold birdfeed. However, as would be understood by persons of ordinary skill in the art, inner bowl 110 can be utilized to hold any substance, whether edible or decorative.

Outer bowl 120 may be constructed of any suitable material that may or may not be capable of floating in a liquid by itself. In addition, outer bowl 120 may be constructed of the same material as inner bowl 110, or constructed of a different material than inner bowl 110, in various embodiments.

Outer bowl 120 is depicted in exemplary FIG. 1A as being substantially circular in shape, from a top view. However, as would be understood by persons of ordinary skill in the art, outer bowl 120 may be of a different shape in other embodiments. For example, outer bowl 120 can be oval, square, rectangle, pentagon, hexagon, septagon, octagon, or any other shape, in various embodiments.

In an exemplary embodiment, outer bowl 120 is utilized to hold an overflow of birdfeed from inner bowl 110. However, as would be understood by persons of ordinary skill in the art, outer bowl 120 can be utilized to hold any substance, whether edible or decorative.

Base plate 130 may be constructed of Styrofoam, plastic, or any other suitable material that floats in a liquid, such as water. In exemplary embodiments, base plate 130 is fixedly attached to inner bowl 110, outer bowl 120, and outer ring 140. In other embodiments, one or more of inner bowl 110, outer bowl 120, and/or outer ring 140 may be removably attached to base plate 130.

Outer ring 140 may be constructed of any suitable material that floats in a liquid, such as water. Outer ring may be shaped in any suitable shape to float in a liquid. For example, outer ring 140 may be of a tube-like shape with an enclosed space for air or a liquid, as depicted in exemplary FIG. 1C. In other embodiments, outer ring 140 may be of a rounded edge shape, as depicted in exemplary FIG. 1B.

The plurality of rods 150 may be constructed of any suitable material that floats in a liquid, such as water. In the exemplary embodiment depicted in FIG. 1A, rods 150 extend downward from the flotation device 100 and outwards from the flotation device 100. Rods 150 may be fixedly or removably attached to outer ring 140, in various embodiments. In other embodiments, rods 150 may be fixedly or removably attached to base plate 140.

Rods 150 extend outwards from the flotation device 100, to allow the flotation device 100 to float around in a body of liquid without the outer ring 140 touching an enclosing perimeter of the body of liquid. In any exemplary embodiment, flotation device 100 floats on top of a swimming pool, and rods 150 ensure that the outer ring 140 of the flotation device 100 is protected from the edges of the swimming pool.

As would be understood by persons of ordinary skill in the art, although only one rod 150 is depicted in exemplary FIG. 1A for simplicity, there can be any number of rods 150 on flotation device 100 in various embodiments, arranged in any configuration.

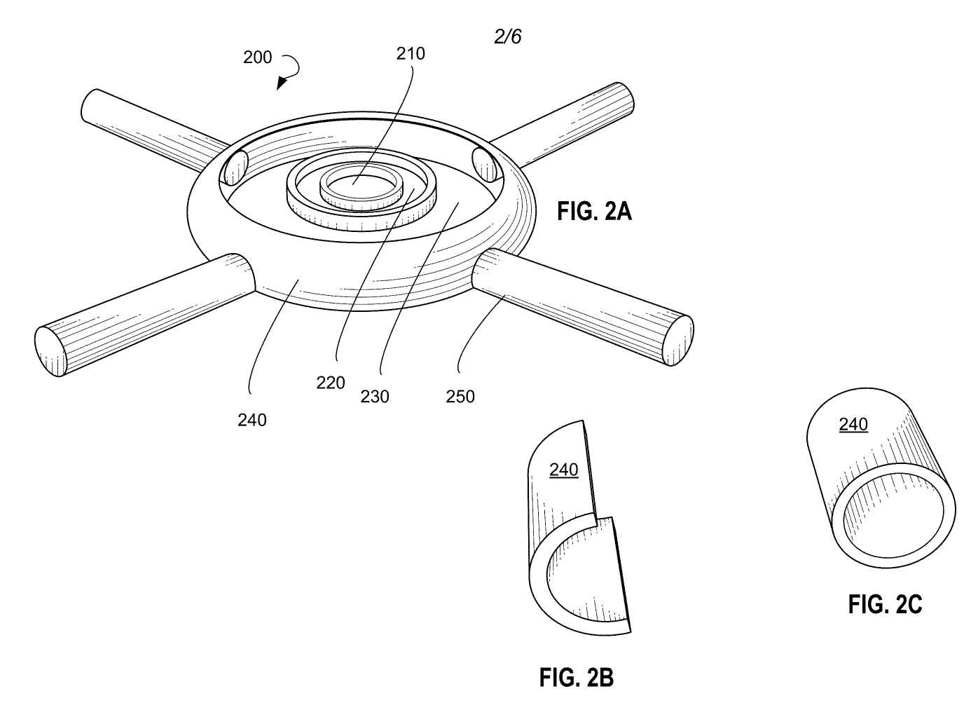

FIG. 2A depicts another exemplary flotation device 200. The flotation device 200 comprises an inner bowl 210, an outer bowl 220, a base plate 230, an outer ring 240, and a plurality of rods 250.

In exemplary embodiments, flotation device 200 can be constructed of Styrofoam, plastic, or any other suitable material that floats in a liquid, such as water. Inner bowl 210 may be constructed of any suitable material that may or may not be capable of floating in a liquid by itself.

Inner bowl 210 is depicted in exemplary FIG. 2A as being substantially circular in shape, from a top view. However, as would be understood by persons of ordinary skill in the art, inner bowl 210 may be of a different shape in other embodiments. For example, inner bowl 210 can be oval, square, rectangle, pentagon, hexagon, septagon, octagon, or any other shape, in various embodiments.

In an exemplary embodiment, inner bowl 210 is utilized to hold birdfeed. However, as would be understood by persons of ordinary skill in the art, inner bowl 210 can be utilized to hold any substance, whether edible or decorative.

Outer bowl 220 may be constructed of any suitable material that may or may not be capable of floating in a liquid by itself. In addition, outer bowl 220 may be constructed of the same material as inner bowl 210, or constructed of a different material than inner bowl 210, in various embodiments.

Outer bowl 220 is depicted in exemplary FIG. 2A as being substantially circular in shape, from a top view. However, as would be understood by persons of ordinary skill in the art, outer bowl 220 may be of a different shape in other embodiments. For example, outer bowl 220 can be oval, square, rectangle, pentagon, hexagon, septagon, octagon, or any other shape, in various embodiments.

In an exemplary embodiment, outer bowl 220 is utilized to hold an overflow of birdfeed from inner bowl 210. However, as would be understood by persons of ordinary skill in the art, outer bowl 220 can be utilized to hold any substance, whether edible or decorative.

Base plate 230 may be constructed of sytrofoam, plastic, or any other suitable material that floats in a liquid, such as water. In exemplary embodiments, base plate 230 is fixedly attached to inner bowl 210, outer bowl 220, and outer ring 240. In other embodiments, one or more of inner bowl 210, outer bowl 220, and/or outer ring 240 may be removably attached to base plate 230.

Outer ring 240 may be constructed of any suitable material that floats in a liquid, such as water. Outer ring 240 may be shaped in any suitable shape to float in a liquid. For example, outer ring 240 may be of a tube-like shape with an enclosed space for air or a liquid, as depicted in exemplary FIG. 2C. In other embodiments, outer ring 240 may be of a rounded edge shape, as depicted in exemplary FIG. 2B.

The plurality of rods 250 may be constructed of any suitable material that floats in a liquid, such as water. In the exemplary embodiment depicted in FIG. 2A, rods 250 extend outwards from the flotation device 200. Rods 150 may be fixedly or removably attached to outer ring 240, in various embodiments.

Rods 250 extend outwards from the flotation device 200, to allow the flotation device 200 to float around in a body of liquid without the outer ring 240 touching an enclosing perimeter of the body of liquid. In any exemplary embodiment, flotation device 200 floats on top of a swimming pool, and rods 250 ensure that the outer ring 240 of the flotation device 200 is protected from the edges of the swimming pool.

As would be understood by persons of ordinary skill in the art, although four rods are depicted in exemplary FIG. 2A for simplicity, there can be any number of rods 250 on flotation device 200 in various embodiments, arranged in any configuration.

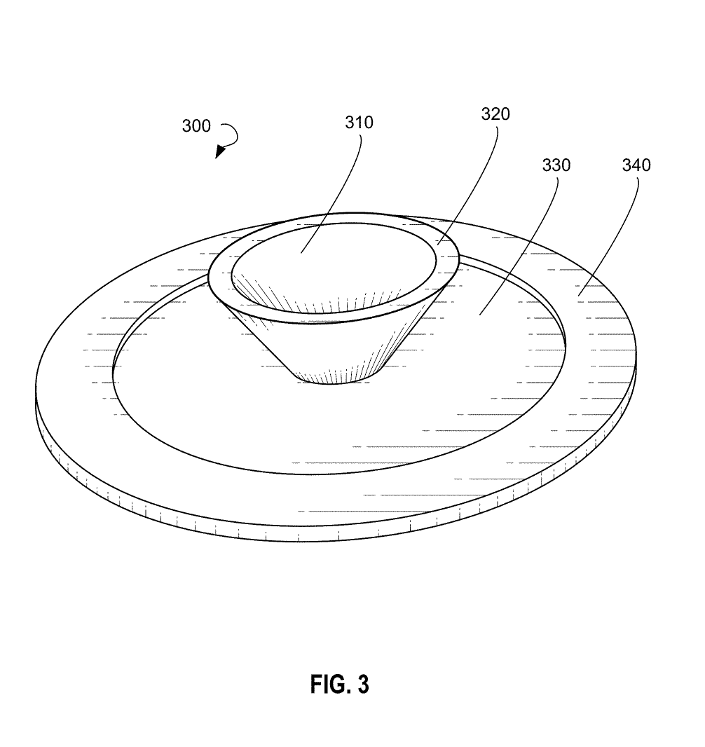

FIG. 3 depicts another exemplary flotation device 300. The flotation device 200 comprises an inner bowl 310, an inner bowl ledge 320, a base plate 330, and an optional outer plate 340.

In exemplary embodiments, flotation device 300 can be constructed of Styrofoam, plastic, or any other suitable material that floats in a liquid, such as water. Inner bowl 310 may be constructed of any suitable material that may or may not be capable of floating in a liquid by itself.

Inner bowl 310 is depicted in exemplary FIG. 3 as being substantially circular in shape, from a top view. However, as would be understood by persons of ordinary skill in the art, inner bowl 310 may be of a different shape in other embodiments. For example, inner bowl 310 can be oval, square, rectangle, pentagon, hexagon, septagon, octagon, or any other shape, in various embodiments.

In an exemplary embodiment, inner bowl 310 is utilized to hold birdfeed. However, as would be understood by persons of ordinary skill in the art, inner bowl 310 can be utilized to hold any substance, whether edible or decorative.

Inner bowl ledge 320 may be constructed of the same material as inner bowl 310, or constructed of a different material than inner bowl 310, in various embodiments. Inner bowl ledge 320 may also comprise a coating or additional material added onto a material of inner bowl 310.

In an exemplary embodiment, inner bowl ledge 320 is configured to allow a bird or other animal to perch upon it while taking birdfeed from inner bowl 310. However, as would be understood by persons of ordinary skill in the art, inner bowl 310 can be utilized to hold any substance, whether edible or decorative.

Base plate 330 may be constructed of Styrofoam, plastic, or any other suitable material that floats in a liquid, such as water. In exemplary embodiments, base plate 330 is fixedly attached to inner bowl 310 and optional outer plate 340. In other embodiments, one or more of inner bowl 310, and/or optional outer plate 340 may be removably attached to base plate 330. In some embodiments, outer plate 340 may be a separate piece attached to base plate 330. In other embodiments, outer plate 340 may simply be a raised section of base plate 330.

Optional outer plate 340 may be constructed of any suitable material that floats in a liquid, such as water. Outer plate 340 may further be shaped in any suitable shape to float in a liquid. Outer plate 340 is depicted in exemplary FIG. 3 as being substantially circular in shape, from a top view. However, as would be understood by persons of ordinary skill in the art, outer plate 340 may be of a different shape in other embodiments. For example, outer plate 340 can be oval, square, rectangle, pentagon, hexagon, septagon, octagon, or any other shape, in various embodiments.

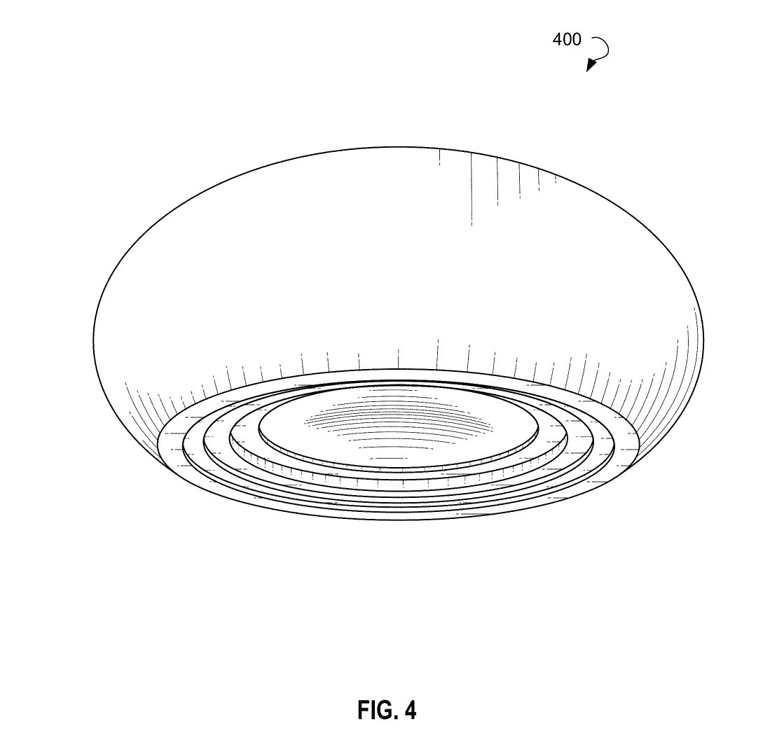

FIG. 4 depicts an underside view of another exemplary flotation device 400. The flotation device 400 may be substantially similar to flotation device 300 of FIG. 3 from a top view. That is, flotation device 400 may comprise an inner bowl, base plate, and optionally an outer plate. However, the underside of flotation device 400 may comprise a concave or cambered structure, as depicted in exemplary FIG. 4. The concave or cambered structure may aid the flotation device 400 in floating atop a body of liquid, in comparison to a substantially flat underside structure.

In other embodiments, the underside of flotation device 400 may be utilized under base plate 130 of flotation device 100 depicted in FIG. 1A, or base plate 230 of flotation device 200 depicted in FIG. 2A.

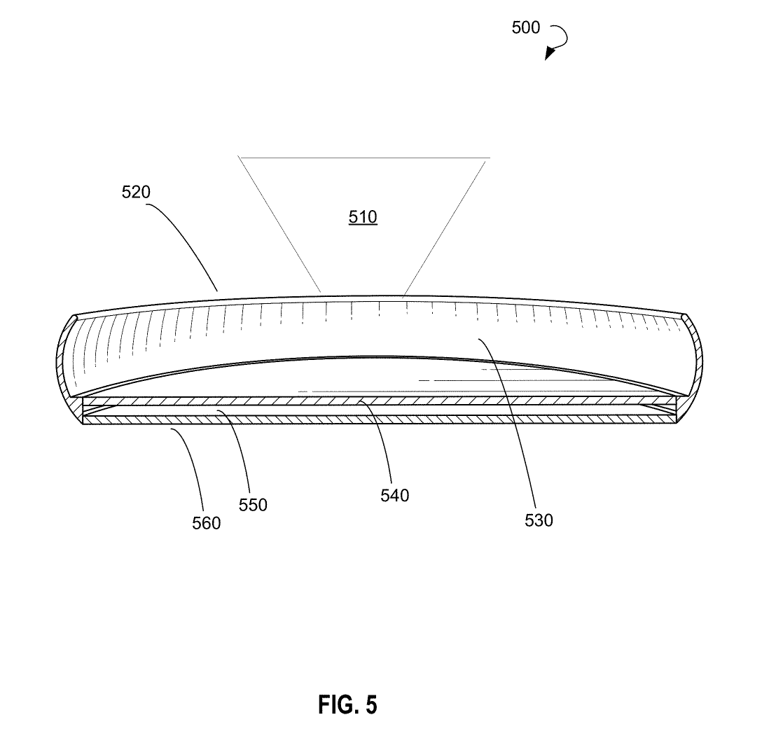

FIG. 5 depicts a side view of another exemplary flotation device 500. The flotation device 500 may be substantially similar to flotation device 300 of FIG. 3 from a top view. That is, flotation device 500 may comprise an inner bowl 510, base plate 520, and optionally an outer plate 530. However, a bottom surface of flotation device 500 may comprise an upper floor 540, a fluid gap 550, and a lower floor 560.

The upper floor 540 and/or lower floor 560 may be constructed of the same or different materials than base plate 520, and may be constructed of a material suitable for floating in liquid. Fluid gap 550 may be an enclosed space between upper floor 540 and lower floor 560 for air or other liquid. The fluid gap 550 aids in flotation of the flotation device 500 atop a body of liquid.

In other embodiments, the underside of flotation device 500 may be utilized under base plate 130 of flotation device 100 depicted in FIG. 1A, or base plate 230 of flotation device 200 depicted in FIG. 2A.

While not explicitly depicted in the exemplary FIG. 5, the upper floor 540 and lower floor 560 may be of substantially the same size as the base plate 520 only, or the same size as the base plate 520 in combination with the outer plate 530. Further, the upper floor 540 and lower floor 560 may be of substantially the same size as one another, or may be of different sizes.

While not explicitly depicted in the figures, any of flotation devices 100, 200, 300, 400, and/or 500 may further comprise at least one waterproof camera, at least one waterproof sensor, and/or wireless communication capability.

The at least one waterproof camera may be placed anywhere on the flotation device, and be configured to monitor an amount of feed or other material remaining within the inner bowl of the flotation device. The at least one waterproof sensor may be placed anywhere on the flotation device, and be configured to monitor a weight of feed or other material remaining within the inner bowl of the flotation device. At least one waterproof sensor may additionally or alternatively be configured to monitor a weight of feed or other material that overflows onto base plate or outer bowl of the flotation device. At least one waterproof sensor may additionally or alternatively be configured to monitor a liquid level on the side of the flotation device, to ensure it floats atop a body of liquid. At least one waterproof sensor may be configured to monitor temperature, time, or any other desirable measurable value.

Flotation device may additionally include wireless communication capability. In one embodiment, the wireless communication capability can be achieved via an antenna attached to any portion of the flotation device. The antenna may be a multi-band antenna that is configured to send or receive communication signals from a number of different frequencies. The antenna may also facilitate other types of wireless communications, such as Bluetooth, ZigBee, Wi-Fi, electromagnetic wave, RFID (radio frequency identification), etc. The antenna may further connect to a microprocessor located on the flotation device as well.

In various embodiments, the antenna can further facilitate wireless communications between a microprocessor and a second computing device, such as a server computer. A human user may further interact with, and control certain operations of the microprocessor on the flotation device via a graphical user interface. The graphical user interface can be accessed by a human user via a web browser on a computing device, such as a desktop or laptop computer, netbook, smartphone, tablet, etc. A human user may further interact with, and control certain operations of the microprocessor on the flotation device via a dedicated software application on a smartphone, tablet, smartwatch, laptop or desktop computer, or any other computing device with a processor that is capable of wireless communication. In other embodiments, a human user can interact with, and control certain operations of the flotation device via a software application utilized by the user for controlling and monitoring other aspects of a residential or commercial building, such as a security system, home monitoring system for Internet-enabled appliances, voice assistant such as Amazon Echo, Google Home, etc.

There may optionally be a housing unit on the flotation device that contains at least one microprocessor, static or main memory, a network interface, at least one power source (such as a battery), and any other electrical components necessary for facilitating wireless communication capabilities. The housing unit may also optionally contain a timer. The microprocessor enables control of the camera and/or sensor(s).

The microprocessor can also operate in concert with a timer to automatically take certain actions at a certain time, time of day, or upon the expiration of a certain amount of time. The housing unit may optionally contain at least one sensor for monitoring an environmental condition, such as temperature of air, temperature of liquid atop which the flotation device rests, humidity level of air, air pressure, GPS coordinates, etc. The at least one sensor can operate in conjunction with the microprocessor and/or timer to program the flotation device to take certain actions if at least one condition is met, such as humidity level of air is at least at a certain threshold level (indicating a likely presence of rain).

In other embodiments, an outside air temperature can be monitored such that the flotation device can be removed from a body of liquid if air temperature is below a threshold level (indicating a likelihood of the body of liquid freezing), or if air temperature is above a certain threshold level (indicating a likelihood of a significant portion of the water simply evaporating into the air). As would be understood by persons of ordinary skill in the art, other types of sensors can be utilized to preset other types of conditions or triggers.

Flotation device may optionally contain a motor, either within the housing unit or outside of the housing unit. The motor may be used to move the flotation device to a different location within the body of liquid that is floating atop. For example, if flotation device comes too close to a side of a swimming pool. Further, this can be used to move the flotation device around any obstruction in the body of liquid within which it is floating.

The housing unit may also comprise an electrical connector interface for electronically coupling a power source to, or for providing power/electricity to the flotation deivce. Electrical connector interface may comprise, for example, an electrical cable (the electrical cable can be any of a charging cable, a FireWire cable, a USB cable, a micro-USB cable, a lightning cable, a retractable cable, a waterproof cable, a cable that is coated/covered with a material that would prevent an animal from chewing through to the electrical wiring, and combinations thereof), electrical ports (such as a USB port, micro-USB port, microSD port, etc.), a connector for batteries (including rechargeable battery, non-rechargeable battery, battery packs, external chargers, portable power banks, etc.), and any other standard power source used to provide electricity/power to household appliances and devices.

In various embodiments, at least one battery may be provided within housing unit instead of, or in addition to, an electrical connector interface. The battery may also have a wireless connection capability for wireless charging, or induction charging capabilities.

The housing unit may further consist of a cover that is easily opened and closed to reveal the components located inside. Further, housing unit may optionally comprise a screen, such as an LCD screen, for viewing a current status. For example, the screen can depict information about liquid flowing below the flotation device, such as flow rate, temperature, duration of liquid flow thus far. In various embodiments, the screen may further depict any other status information such as battery power, amount of feed remaining in inner bowl, any errors in operational status of components, etc. The screen is also waterproof to protect against any accidental splashing of liquid.

While also not explicitly depicted in the figures, any of flotation device 100, 200, 300, 400, and/or 500 may further comprise a surplus animal feed container. When an amount of feed in the inner bowl reaches a certain low threshold, it can be replenished with feed from the surplus animal feed container. The replenishing can happen manually by a human user, either upon notification by the flotation device sensor that the feed is low, or upon manual visual inspection by the human user. Further, flotation device may be programmed to automatically replenish animal feed in the inner bowl from the surplus feed container if a certain low threshold of feed is reached, as detected by a sensor on the flotation device.

The surfaces of any of flotation device 100, 200, 300, 400, and/or 500 may be smooth or textured. Further, any of the surfaces may be constructed from waterproof materials such as plastic, BPA-free plastic, polymer, metal, stainless steel, aluminum, silicone, fiberglass, or combinations thereof. Additionally, or alternatively, any surface of flotation device 100, 200, 300, 400, and/or 500 may be coated with a waterproof coating material.

In an exemplary use case, a human user can utilize a software application running on a smartphone or tablet to detect that a water level of the swimming pool is lower than desired. This can be detected through cameras accessed through the software application, to view the water level of the swimming pool within which the flotation device is floating. Alternatively, a sensor can detect a water level of a swimming pool and relay that information to the human user via a software application. The user may determine, either through remote viewing of cameras, or through remote viewing of sensor data, that the swimming pool has enough water.

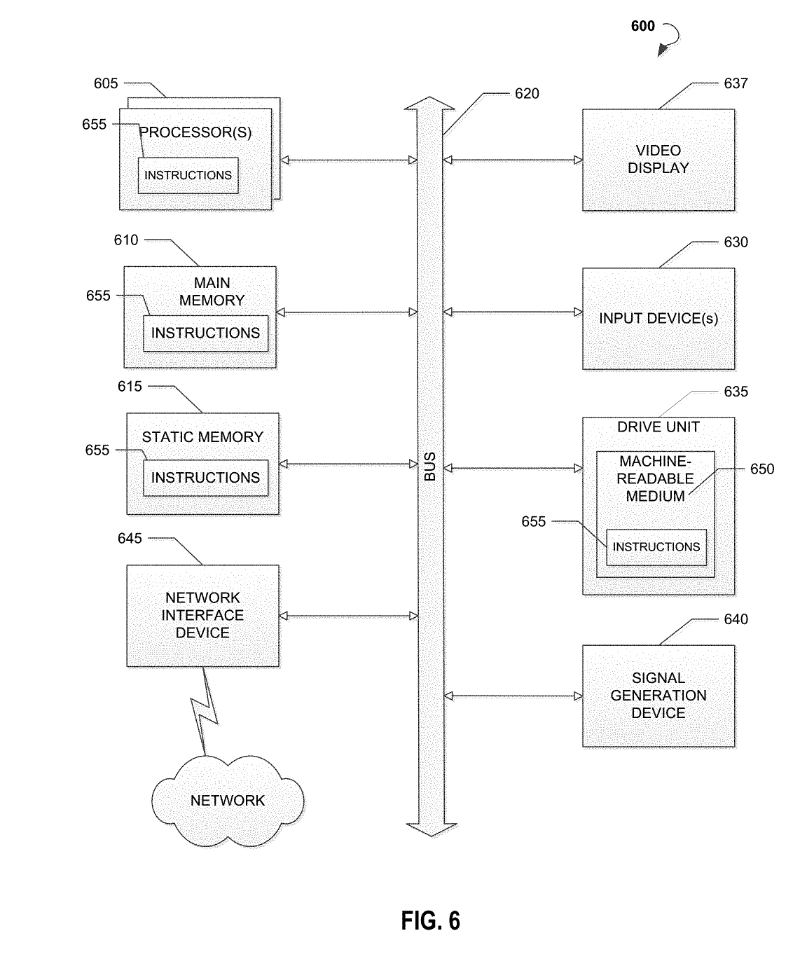

FIG. 6 is a diagrammatic representation of an example machine, or computing unit, in the form of a computer system 600, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor or multiple processors 605 (e.g., a central processing unit (CPU), a graphics processing unit (GPU), or both), and one or more of a main memory 610 or static memory 615, which communicate with each other via a bus 620. The computer system 600 may further include a video display 637 (e.g., a liquid crystal display (LCD)). The computer system 600 may also include an alpha-numeric input device(s) 630 (e.g., a keyboard), a cursor control device (e.g., a mouse), a voice recognition or biometric verification unit (not shown), a drive unit 635 (also referred to as disk drive unit), a signal generation device 640 (e.g., a speaker), and a network interface device 645. The computer system 600 may further include a data encryption module (not shown) to encrypt data.

The drive unit 635 includes a computer or machine-readable medium 650 on which is stored one or more sets of instructions and data structures (e.g., instructions 655) embodying or utilizing any one or more of the methodologies or functions described herein. The instructions 655 may also reside, completely or at least partially, within the main memory 610 and/or within the processors 605 during execution thereof by the computer system 600. The main memory 610 and the processors 605 may also constitute machine-readable media.

The instructions 655 may further be transmitted or received over a network via the network interface device 645 utilizing any one of a number of well-known transfer protocols (e.g., Hyper Text Transfer Protocol (HTTP)). While the machine-readable medium 650 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

Aspects of the present technology are described above with reference to flowchart illustrations and/or block diagrams of methods, apparatus (systems) and computing products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In the above description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), and a plural term may be indicated with or without an apostrophe (e.g., PE's or PEs). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

The terminology used herein is for the purpose of describing particular embodiments only and is not intended to be necessarily limiting of the disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence or addition of one or more other features, integers, steps, operations, elements, components, and/or groups thereof.

It is noted at the outset that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data/control information) to the second entity regardless of the type (analog or digital) of those signals. It is further noted that various figures (including component diagrams) shown and discussed herein are for illustrative purpose only, and are not drawn to scale.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present.

Although the terms first, second, etc. may be used herein to describe various elements, components, regions, layers and/or sections, these elements, components, regions, layers and/or sections should not necessarily be limited by such terms. These terms are only used to distinguish one element, component, region, layer or section from another element, component, region, layer or section. Thus, a first element, component, region, layer or section discussed below could be termed a second element, component, region, layer or section without departing from the teachings of the present disclosure.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Any and/or all elements, as disclosed herein, can be formed from a same, structurally continuous piece, such as being unitary, and/or be separately manufactured and/or connected, such as being an assembly and/or modules. Any and/or all elements, as disclosed herein, can be manufactured via any manufacturing processes, whether additive manufacturing, subtractive manufacturing and/or other any other types of manufacturing. For example, some manufacturing processes include three dimensional (3D) printing, laser cutting, computer numerical control (CNC) routing, milling, pressing, stamping, vacuum forming, hydroforming, injection molding, lithography and/or others.

Any and/or all elements, as disclosed herein, can include, whether partially and/or fully, a solid, including a metal, a mineral, a ceramic, an amorphous solid, such as glass, a glass ceramic, an organic solid, such as wood and/or a polymer, such as rubber, a composite material, a semiconductor, a nano-material, a biomaterial and/or any combinations thereof. Any and/or all elements, as disclosed herein, can include, whether partially and/or fully, a coating, including an informational coating, such as ink, an adhesive coating, a melt-adhesive coating, such as vacuum seal and/or heat seal, a release coating, such as tape liner, a low surface energy coating, an optical coating, such as for tint, color, hue, saturation, tone, shade, transparency, translucency, non-transparency, luminescence, anti-reflection and/or holographic, a photo-sensitive coating, an electronic and/or thermal property coating, such as for passivity, insulation, resistance or conduction, a magnetic coating, a water-resistant and/or waterproof coating, a scent coating and/or any combinations thereof.

Unless otherwise defined, all terms (including technical and scientific terms) used herein have the same meaning as commonly understood by one of ordinary skill in the art to which this disclosure belongs. The terms, such as those defined in commonly used dictionaries, should be interpreted as having a meaning that is consistent with their meaning in the context of the relevant art and should not be interpreted in an idealized and/or overly formal sense unless expressly so defined herein.

Furthermore, relative terms such as “below,” “lower,” “above,” and “upper” may be used herein to describe one element's relationship to another element as illustrated in the accompanying drawings. Such relative terms are intended to encompass different orientations of illustrated technologies in addition to the orientation depicted in the accompanying drawings. For example, if a device in the accompanying drawings is turned over, then the elements described as being on the “lower” side of other elements would then be oriented on “upper” sides of the other elements. Similarly, if the device in one of the figures is turned over, elements described as “below” or “beneath” other elements would then be oriented “above” the other elements. Therefore, the example terms “below” and “lower” can, therefore, encompass both an orientation of above and below.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A flotation device apparatus configured to float atop a body of liquid, the flotation device apparatus comprising:
an inner bowl configured to contain a material;
an outer bowl located concentrically around the inner bowl;
an outer ring located concentrically around the outer bowl;
a base plate attached to the inner bowl, outer bowl, and outer ring; and
a plurality of rods extending outwards from the outer ring.

2. The flotation device apparatus of claim 1, wherein the plurality of rods extend in a downward direction from the outer ring before extending outwards from the outer ring.

3. The flotation device apparatus of claim 1, wherein the inner bowl is configured to contain bird feed.

4. The flotation device apparatus of claim 1, wherein the outer ring comprises a tube-like structure with an enclosed air space.

5. The flotation device apparatus of claim 1, wherein the outer ring comprises an open arc-like structure.

6. The flotation device apparatus of claim 1, wherein the apparatus floats atop a swimming pool.

7. The flotation device apparatus of claim 1, further comprising an antenna configured to transmit and receive wireless communications to or from a computing unit.

8. The flotation device apparatus of claim 7, wherein the antenna is configured to transmit and receive wireless communications via at least one of Bluetooth, Wi-Fi, RFID, or electromagnetic waves.

9. The flotation device apparatus of claim 7, further comprising a housing unit comprising:
a microprocessor operating in conjunction with the antenna to transmit and receive the wireless communications to or from the computing unit;
a computing memory operating in conjunction with the microprocessor; and
an electrical connector interface for coupling to a power source.

10. The flotation device apparatus of claim 1, further comprising at least one sensor to monitor a condition on or around the flotation device.

11. The flotation device apparatus of claim 1, further comprising a motor configured to move the apparatus within the body of liquid.

12. A flotation device apparatus configured to float atop a body of liquid, the flotation device apparatus comprising:
an inner bowl configured to contain a material;
an inner bowl ledge around an upper edge of the inner bowl; and
a base plate attached to a bottom surface of the inner bowl.

13. The flotation device apparatus of claim 12, further comprising an outer plate attached concentrically around the base plate.

14. The flotation device apparatus of claim 12, wherein the base plate further comprises:
an upper floor;
a lower floor; and
a fluid gap between the upper floor and the lower floor.

15. The flotation device apparatus of claim 12, wherein the inner bowl is configured to contain bird feed.

16. The flotation device apparatus of claim 12, wherein the apparatus floats atop a swimming pool.

17. The flotation device apparatus of claim 12, further comprising at least one sensor to monitor a condition on or around the flotation device.

18. The flotation device apparatus of claim 12, further comprising a motor configured to move the apparatus within the body of liquid.

19. The flotation device apparatus of claim 12, wherein a bottom surface of the base plate is of a concave structure.

20. The flotation device apparatus of claim 12, wherein a bottom surface of the base plate is of a cambered structure.
